(19) United States
(12) Patent Application Publication
(10) Pub. No.: US 2025/0162832 A1
(43) Pub. Date: May 22, 2025

(54) MEDIUM PROCESSING APPARATUS AND IMAGE FORMING SYSTEM INCORPORATING SAME

(71) Applicant: Takahiro Itou, KANAGAWA (JP)

(72) Inventor: Takahiro Itou, KANAGAWA (JP)

(73) Assignee: Ricoh Company, Ltd., Tokyo (JP)

(21) Appl. No.: 18/933,057

(22) Filed: Oct. 31, 2024

(30) Foreign Application Priority Data
Nov. 21, 2023 (JP) 2023-197422

(51) Int. Cl. B65H 37/04; B31F 5/02

(52) U.S. Cl. CPC B65H 37/04; B31F 5/02; B65H 2301/51616; B65H 2801/27

(57) ABSTRACT

A medium processing apparatus includes a placing portion, a crimp binder, and circuitry. Multiple media including a medium are placed on the placing portion. The crimp binder applies pressure and deforms the multiple media to bind the multiple media on the placing portion as a crimp binding process. The circuitry is to, when binding N sheets of the multiple media, cause the crimp binder to perform the crimp binding process when M sheets of the multiple media smaller than the N sheets (M<N) are placed on the placing portion, and cause the crimp binder to perform the crimp binding process again when all the N sheets of the multiple media are placed on the placing portion.

### CROSS-REFERENCE TO RELATED APPLICATION

This patent application is based on and claims priority pursuant to 35 U.S.C. § 119(a) to Japanese Patent Application No. 2023-197422, filed on Nov. 21, 2023, in the Japan Patent Office, the entire disclosure of which is hereby incorporated by reference herein.

### BACKGROUND

### Technical Field

Embodiments of the present disclosure relate to a medium processing apparatus and an image forming system incorporating the medium processing apparatus.

### Background Art

Various medium processing apparatuses are known that include: a stacking tray on which a sheet-shaped medium on which an image is formed by an image forming apparatus is stacked; and a binding unit that binds a plurality of media stacked on the stacking tray into a bundle (hereinafter, referred to as a “bundle of recording media”).

Among such medium processing apparatuses, from the viewpoint of saving resources and reducing environmental loads, there is a medium processing apparatus that can perform so-called “crimp binding.” The crimp binding is binding in which a bundle of recording media is sandwiched and pressure-deformed by serrate binding teeth without using a metal staple.

However, a binding force by the binding teeth is less likely to be transmitted to a middle part of the bundle of recording media. Therefore, there is a problem that the crimped and bound bundle of recording media is likely to be separated afterwards when the number of media included in the bundle of recording media increases.

### SUMMARY

Embodiments of the present disclosure described herein provide a novel medium processing apparatus includes a placing portion, a crimp binder, and circuitry. Multiple media including a medium are placed on the placing portion. The crimp binder applies pressure and deform the multiple media to bind the multiple media on the placing portion as a crimp binding process. The circuitry is to, when binding N sheets of the multiple media, cause the crimp binder to perform the crimp binding process when M sheets of the multiple media smaller than the N sheets (M<N) are placed on the placing portion, and cause the crimp binder to perform the crimp binding process again when all the N sheets of the multiple media are placed on the placing portion.

Further, embodiments of the present disclosure described herein provide an image forming system including an image forming apparatus to form an image on a medium, and the above-described medium processing apparatus.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating an overall configuration of an image forming system according to an embodiment of the present disclosure;

FIG. 2 is a diagram illustrating an internal configuration of a post-processing apparatus according to a first embodiment of the present disclosure;

FIG. 3 is a schematic diagram illustrating an upstream side of an edge binder of the post-processing apparatus of FIG. 2 in a conveyance direction;

FIG. 4 is a schematic diagram illustrating a configuration of a liquid applier of the edge binder of FIG. 3 in a main scanning direction;

FIGS. 5A and 5B are schematic diagrams each illustrating a configuration of a crimper according to an embodiment of the present disclosure;

FIGS. 6A and 6B are diagrams illustrating a contact-separation mechanism that causes upper crimping teeth and lower crimping teeth to be in contact with and separated from each other;

FIG. 7 is a diagram illustrating a modification of the edge binder of FIG. 3;

FIGS. 8A, 8B, and 8C are diagrams illustrating a liquid application crimper in the edge binder of FIG. 7;

FIGS. 9A, 9B, and 9C are diagrams each illustrating a liquid application operation and a crimp binding operation performed by the liquid application crimper of FIGS. 8A, 8B, and 8C;

FIG. 10 is a block diagram illustrating a hardware configuration of the post-processing apparatus of FIG. 2 to control the post-processing apparatus;

FIG. 11 is a flowchart of a binding process performed by the edge binder of FIG. 3;

FIGS. 12A, 12B, and 12C are diagrams each illustrating positions of the liquid applier and the crimper during the binding process by the edge binder in FIG. 11;

FIGS. 13A and 13B are diagrams illustrating a binding force in a case where a sheet bundle is crimped and bound;

FIG. 14 is a flowchart of a binding number determination process;

FIG. 15 is a flowchart of a binding process of performing crimp binding twice;

FIGS. 16A and 16B are diagrams illustrating a state of a sheet bundle in a case of applying liquid to the same binding position;

FIGS. 17A, 17B, 17C, 17D, and 17E are diagrams illustrating a state of a sheet bundle in a case of binding at the same binding position twice;

FIGS. 18A and 18B are diagrams illustrating a state of a sheet bundle in a case of applying liquid to different binding positions;

FIGS. 19A, 19B, 19C, 19D, and 19E are diagrams illustrating a state of a sheet bundle in a case of binding at different binding positions;

FIGS. 20A, 20B, 20C, and 20D are diagrams illustrating variations of binding positions; and

FIGS. 21A, 21B, and 21C are diagrams illustrating a comparison of binding forces of the binding process of FIG. 11 and the binding process of FIG. 15.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

A description is given below of an image forming system 1 according to an embodiment of the present disclosure, with reference to the drawings.

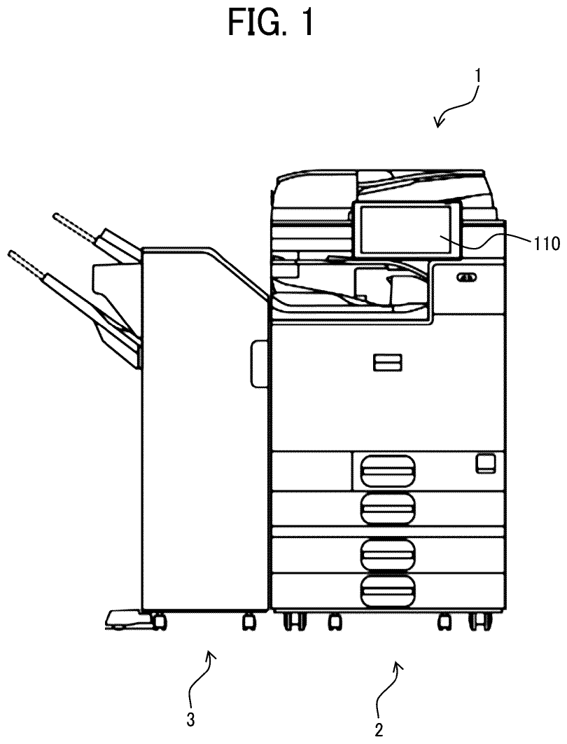

FIG. 1 is a diagram illustrating the overall configuration of the image forming system 1.

The image forming system 1 has a function of forming an image on a sheet P as a sheet-shaped medium and performing post-processing on the sheet P on which the image is formed.

As illustrated in FIG. 1, the image forming system 1 includes an image forming apparatus 2 and a post-processing apparatus 3 serving as a medium processing apparatus according to embodiments of the present disclosure.

The image forming apparatus 2 forms an image on the sheet P and outputs the sheet P having the image to the post-processing apparatus 3. The image forming apparatus 2 includes a tray that accommodates the sheet P, a conveyor that conveys the sheet P accommodated in the tray, and an image former that forms an image on the sheet P conveyed by the conveyor. The image former may be an inkjet image forming device that forms an image with ink or an electrophotographic image former that forms an image with toner. Since the image forming apparatus 2 has a typical configuration, a detailed description of the configuration and functions of the image forming apparatus 2 are omitted.

A description is given of the post-processing apparatus 3 according to a first embodiment of the present disclosure.

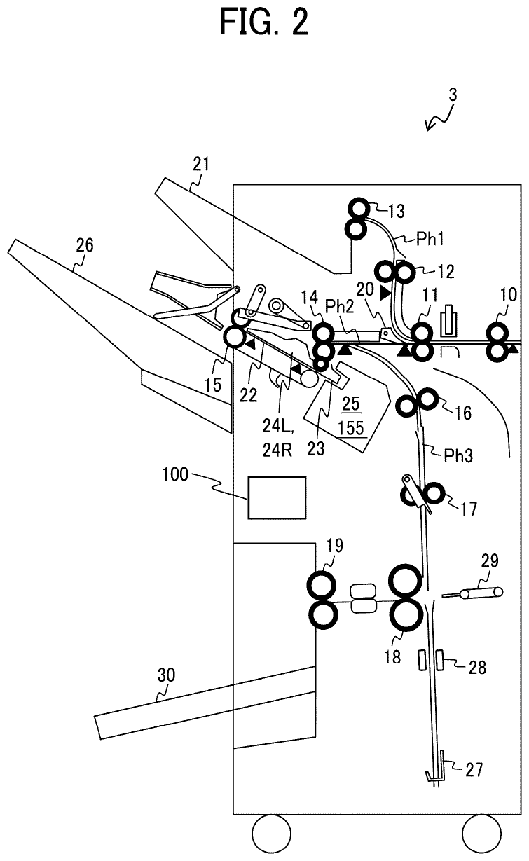

FIG. 2 is a diagram illustrating an internal configuration of the post-processing apparatus 3 according to the first embodiment of the present disclosure.

The post-processing apparatus 3 performs a post-processing process on the sheet P on which an image is formed by the image forming apparatus 2. An example of the post-processing according to the present embodiment is binding or a binding process as a “crimp binding process” to bind, without staples, a plurality of sheets P on each of which an image is formed as a bundle of sheets P, which may be referred to as a sheet bundle. Another example of the post-processing according to the present embodiment is binding or a binding process as a “stapling process” to bind, with staples, a plurality of sheets P on each of which an image is formed as a bundle of sheets P (i.e., sheet bundle). In the following description, the bundle of sheets P as a bundle of recording media may be referred to as a “sheet bundle Pb.”

More particularly, the “crimp binding process” according to the present embodiment is a process called “crimp binding” to apply pressure to a binding position corresponding to a part of the sheet bundle Pb to deform (pressure-deform) the binding position and bind the sheet bundle Pb. The binding that can be executed by the post-processing apparatus 3 includes edge binding and saddle stitching. The edge binding is a process to bind an end (including an edge) of the sheet bundle Pb. The saddle stitching is a process to bind a center of the sheet bundle Pb.

The post-processing apparatus 3 includes conveyance roller pairs 10, 11, 12, 13, 14, 15, 16, 17, 18, and 19 serving as conveyors and a switching plate 20. The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance passage Ph1. The conveyance roller pairs 14 and 15 convey the sheet P along a second conveyance passage Ph2. The conveyance roller pairs 16 to 19 convey the sheet P along a third conveyance passage Ph3.

The first conveyance passage Ph1 is a passage extending to an output tray 21 from a supply port through which the sheet P is supplied from the image forming apparatus 2. The second conveyance passage Ph2 is a passage branching from the first conveyance passage Ph1 between the conveyance roller pairs 11 and 14 in a conveyance direction and extending to an output tray 26 via an internal tray 22. The third conveyance passage Ph3 is a passage branching from the first conveyance passage Ph1 between the conveyance roller pairs 11 and 14 in the conveyance direction and extending to an output tray 30.

The switching plate 20 serving as a switcher is disposed at a branching position of the first conveyance passage Ph1 and the second conveyance passage Ph2.

The switching plate 20 can change the position between a first position and a second position. The switching plate 20 at the first position guides the sheet P to be output to the output tray 21 through the first conveyance passage Ph1. The switching plates 20 at the second position guides the sheet P conveyed through the first conveyance passage Ph1 to the second conveyance passage Ph2. When a trailing end of the sheet P entering the second conveyance passage Ph2 passes through the conveyance roller pair 11, the conveyance roller pair 14 is rotated in reverse to guide the sheet P to the third conveyance passage Ph3. The post-processing apparatus 3 further includes a plurality of sensors that detects the positions of the sheet P in the first conveyance passage Ph1, the second conveyance passage Ph2, and the third conveyance passage Ph3. Each of the plurality of sensors is indicated by a black triangle mark in FIG. 2.

The post-processing apparatus 3 includes the output tray 21. The sheet P that is output through the first conveyance passage Ph1 is placed on the output tray 21. Among the sheets P supplied from the image forming apparatus 2, the sheets P that are not bound are output to the output tray 21.

The post-processing apparatus 3 further includes the internal tray 22 (placing portion) serving as a receptacle, an end fence 23, side fences 24L and 24R, an edge binder 25, a stapling unit 155, and the output tray 26. The internal tray 22, the end fence 23, the side fences 24L and 24R, the edge binder 25, and the stapling unit 155 perform the edge binding on the sheet bundle Pb constructed of the plurality of sheets P conveyed through the second conveyance passage Ph2. Among the sheets P supplied from the image forming apparatus 2, the sheet bundle Pb subjected to the edge binding is output to the output tray 26.

The “edge binding” includes “parallel binding,” “oblique binding,” and “vertical binding.” The “parallel binding” is a process to bind the sheet bundle Pb along one side of the sheet bundle Pb parallel to a main scanning direction. The “oblique binding” is a process to bind a corner of the sheet bundle Pb. The “vertical binding” is a process to bind the sheet bundle Pb along one side of the sheet bundle Pb parallel to the conveyance direction.

In the following description, a direction in which the sheet P is conveyed from the conveyance roller pair 15 toward the end fence 23 is defined as a “conveyance direction” of the sheet P. In other words, the “conveyance direction” herein corresponds to a direction in which the sheet P that has been output from the image forming apparatus 2 is moved toward the output tray 26 by, for example, the conveyance roller pair 10 and then is moved toward the end fence 23 by the conveyance roller pair 15. A direction that is orthogonal to the conveyance direction and a thickness direction of the sheet P is defined as a “main scanning direction” or a “width direction of the sheet P.”

The sheets P that are sequentially conveyed through the second conveyance passage Ph2 are temporarily placed on the internal tray 22 serving as a receptacle. The end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the stapling unit 155 bind an end of the sheet bundle Pb aligned by the end fence 23 and the side fences 24L and 24R. Then, the conveyance roller pair 15 outputs the sheet bundle Pb subjected to the edge binding to the output tray 26.

The post-processing apparatus 3 further includes an end fence 27, a saddle stitcher 28, a sheet folding blade 29, and the output tray 30. The end fence 27, the saddle stitcher 28, and the sheet folding blade 29 perform the saddle stitching on the sheet bundle Pb constructed of the sheets P that are conveyed through the third conveyance passage Ph3. Among the sheets P supplied from the image forming apparatus 2, the sheet bundle Pb subjected to the saddle stitching is output to the output tray 30.

The end fence 27 aligns the positions of the sheets P that are sequentially conveyed through the third conveyance passage Ph3, in a direction in which the sheets P are conveyed. The end fence 27 can move between a binding position where the end fence 27 causes a center of the sheet bundle Pb to face the saddle stitcher 28 and a folding position where the end fence 27 causes the center of the sheet bundle Pb to face the sheet folding blade 29. The saddle stitcher 28 binds the center of the sheet bundle Pb aligned by the end fence 27 at the binding position. The sheet folding blade 29 folds, in half, the sheet bundle Pb placed on the end fence 27 at the folding position and causes the conveyance roller pair 18 to nip the sheet bundle Pb. The conveyance roller pairs 18 and 19 output the sheet bundle Pb subjected to the saddle stitching to the output tray 30.

A detailed description is given of the edge binder 25 according to an embodiment of the present disclosure.

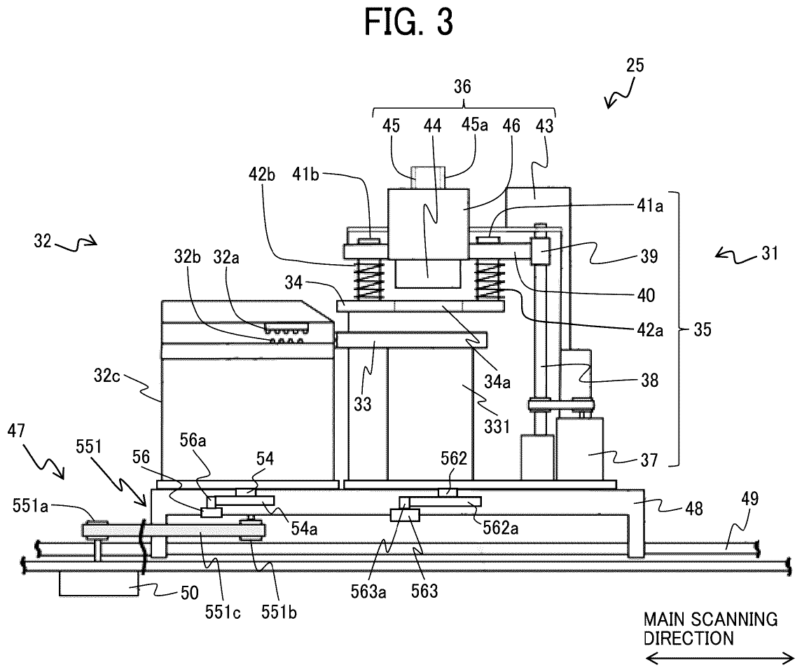

FIG. 3 is a schematic view of an upstream side of the edge binder 25 in the conveyance direction. The edge binder 25 performs liquid application and crimp binding.

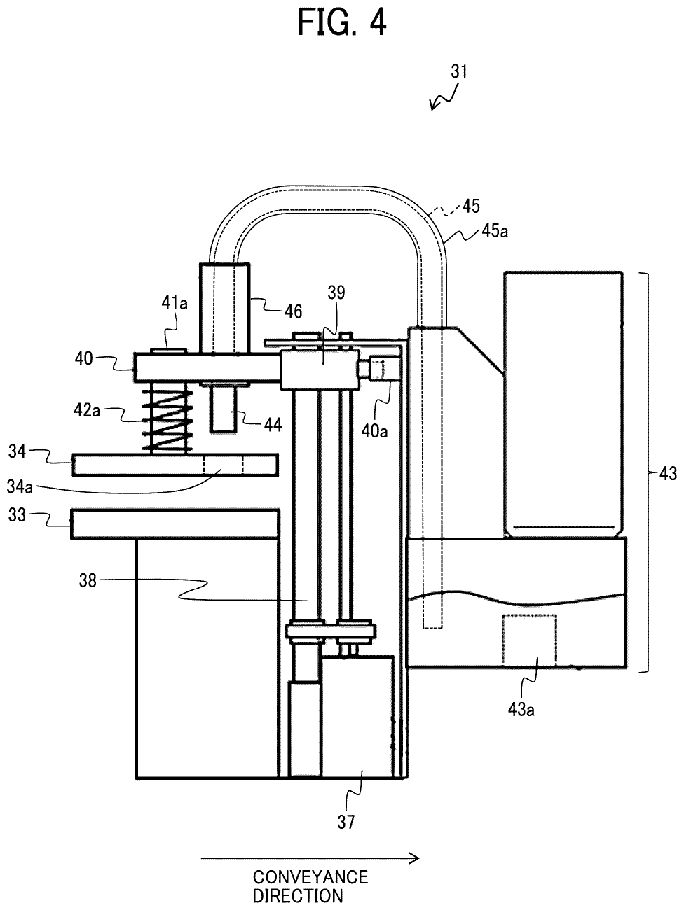

FIG. 4 is a schematic diagram illustrating a liquid applier 31 of the edge binder 25 when viewed from the main scanning direction.

As illustrated in FIGS. 3 and 4, the edge binder 25 includes the liquid applier 31 (liquid application device) that executes a processing operation related to liquid application, and a crimper 32 (crimp binding device) that is an example of a post-processing device and performs the crimp binding process. The liquid applier 31 and the crimper 32 are disposed downstream from the internal tray 22 in the conveyance direction and adjacent to each other in the main scanning direction.

The liquid applier 31 applies liquid that is stored in a liquid storage tank 43 to the sheet P or the sheet bundle Pb placed on the internal tray 22. In the following description, the application of liquid to the sheet P or the sheet bundle Pb may be referred to as “liquid application” while a process to apply liquid may be referred to as a “liquid application process.”

More specifically, the liquid that is stored in the liquid storage tank 43 to be applied includes, as a main component, the liquid state of a compound of hydrogen and oxygen represented by the chemical formula H20. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid that is stored in the liquid storage tank 43 may include an additive in addition to the main component. The liquid that is stored in the liquid storage tank 43 may include residual chlorine used as tap water. Preferably, for example, the liquid that is stored in the liquid storage tank 43 may include, as an additive, a colorant, a penetrant, a pH adjuster, a preservative such as phenoxyethanol, a drying inhibitor such as glycerin, or a combination thereof. Since water is used as a component of ink used for inkjet printers or ink used for water-based pens, such water or ink may be used for the “liquid application.”

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above can enhance the binding strength of the sheet bundle Pb, as compared with a liquid of which the main component is not water.

A description is given of the configurations of the liquid applier 31 and the crimper 32.

The liquid applier 31 and the crimper 32 can be moved together in the main scanning direction by a driving force transmitted from an edge-binder movement motor 50. A liquid application position to which the liquid is applied on the sheet P or the sheet bundle Pb by the liquid applier 31 corresponds to a crimp binding position to be crimped and bound by the crimper 32. For this reason, in the following description, the liquid application position and the crimp binding position are denoted by the same reference numeral.

As illustrated in FIGS. 3 and 4, the liquid applier 31 can be moved in the main scanning direction together with the crimper 32 by the driving force transmitted from the edge-binder movement motor 50.

The liquid applier 31 includes a lower pressure plate 33 serving as a receptacle for the sheet P or the sheet bundle Pb, an upper pressure plate 34, a liquid-applier movement assembly 35, and a liquid application assembly 36. The components of the liquid applier 31 such as the lower pressure plate 33, the upper pressure plate 34, the liquid-applier movement assembly 35, and the liquid application assembly 36 are held by a liquid application frame 31a and a base 48.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, in a space where the lower pressure plate 33 and the upper pressure plate 34 face each other, the lower pressure plate 33 and the upper pressure plate 34 are disposed to face each other in the thickness direction of the sheet P or the sheet bundle Pb so as to sandwich the sheet P or the sheet bundle Pb placed on the internal tray 22. In the following description, the thickness direction of the sheet P or the sheet bundle Pb may be referred to simply as “thickness direction.” The upper pressure plate 34 has a through hole 34a penetrating in the thickness direction at a position where the through hole 34a faces an end of a liquid application member 44 held via a joint 46 attached to a base plate 40.

The liquid-applier movement assembly 35 moves the upper pressure plate 34, the base plate 40, and the liquid application member 44 in the thickness direction of the sheet P or the sheet bundle Pb. The liquid-applier movement assembly 35 according to the present embodiment moves the upper pressure plate 34, the base plate 40, and the liquid application member 44 in conjunction with each other by a single liquid-applier movement motor 37. The liquid-applier movement assembly 35 includes, for example, the liquid-applier movement motor 37, a trapezoidal screw 38, a nut 39, the base plate 40, columns 41a and 41b, and coil springs 42a and 42b.

The liquid-applier movement motor 37 generates a driving force to move the upper pressure plate 34, the base plate 40, and the liquid application member 44. The trapezoidal screw 38 extends in the thickness direction of the sheet P or the sheet bundle Pb and is attached to the liquid application frame 31a so as to be rotatable in the forward and reverse directions. The trapezoidal screw 38 is coupled to an output shaft of the liquid-applier movement motor 37 via, for example, a pulley and a belt. The nut 39 is screwed to the trapezoidal screw 38. The trapezoidal screw 38 is rotated in the forward and reverse directions by the driving force transmitted from the liquid-applier movement motor 37. The rotation of the trapezoidal screw 38 causes the nut 39 to reciprocate on the trapezoidal screw 38.

The base plate 40 is positioned apart from the upper pressure plate 34.

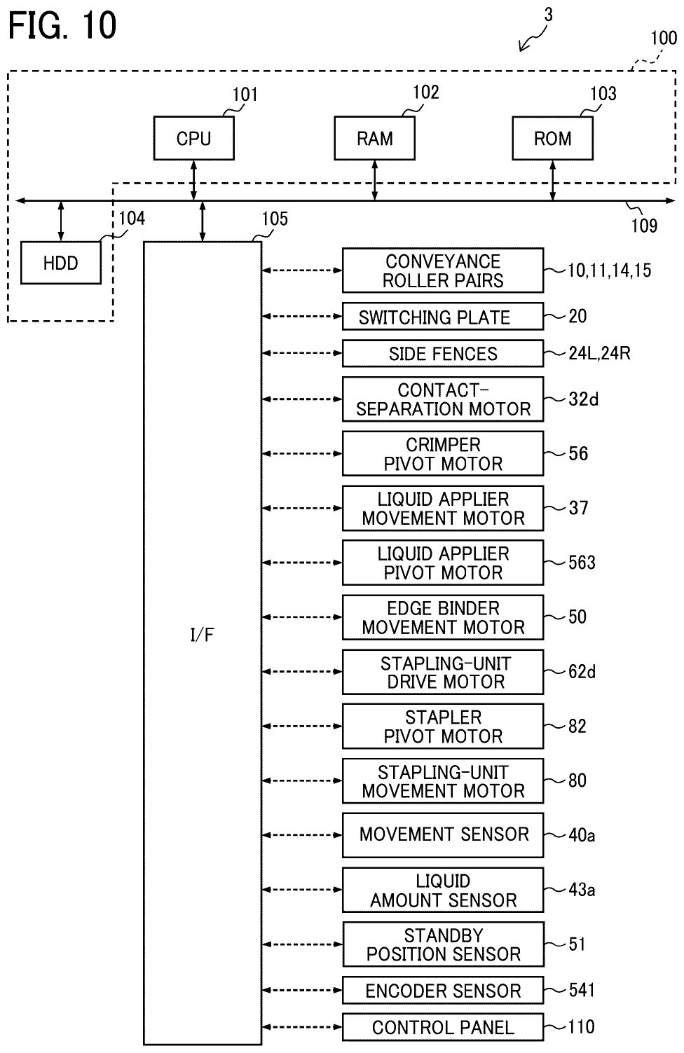

The base plate 40 holds the liquid application member 44 with the end of the liquid application member 44 projecting from the base plate 40 toward the upper pressure plate 34. The base plate 40 is coupled to the trapezoidal screw 38 via the nut 39 such that the base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 10).

The columns 41a and 41b project from the base plate 40 toward the upper pressure plate 34 around the end of the liquid application member 44. The columns 41a and 41b are movable relative to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40. The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid application assembly 36 applies liquid to the sheet P or the sheet bundle Pb placed on the internal tray 22. More particularly, the liquid application assembly 36 brings the end of the liquid application member 44 into contact with the sheet P or the sheet bundle Pb to apply the liquid to at least one sheet P of the sheet bundle Pb. The liquid application assembly 36 includes the liquid storage tank 43, the liquid application member 44, a liquid supplier 45, and the joint 46.

The liquid storage tank 43 stores the liquid to be supplied to the sheet P or the sheet bundle Pb. The amount of liquid that is stored in the liquid storage tank 43 is detected by a liquid amount sensor 43a. The liquid application member 44 applies the liquid stored in the liquid storage tank 43 to the sheet P or the sheet bundle Pb. The liquid application member 44 is attached to the base plate 40 with the end of the liquid application member 44 oriented toward the upper pressure plate 34.

The liquid application member 44 is made of a porous material having a relatively high liquid absorption or a fiber material that can absorb liquid by capillary action. The liquid application member 44 is not limited to a particular kind provided that the liquid application member 44 is made of a material having a property of absorbing and holding the liquid and has a property of being crushed according to a pressing force applied when the liquid application member 44 is in contact with the sheet P. For example, the liquid application member 44 may be a foam material such as a sponge or a fiber material that can absorb liquid by capillary action.

The liquid supplier 45 is an elongated member having a base end (proximal end) immersed in the liquid stored in the liquid storage tank 43 and a distal end coupled to the liquid application member 44. Like the liquid application member 44, for example, the liquid supplier 45 is made of a material having a relatively high liquid absorption. Accordingly, the liquid is absorbed from the base end of the liquid supplier 45 and travels through the liquid supplier 45 by capillary action to be supplied to the liquid application member 44. Although the liquid application member 44 and the liquid supplier 45 are separately disposed in the embodiment described above, the liquid application member 44 and the liquid supplier 45 may be made of materials having like properties to be a single unit. In this case, like the embodiment described above, the liquid that is stored in the liquid storage tank 43 is absorbed by capillary action. This case further attains cost reduction.

A protector 45a is an elongated cylindrical body (for example, a tube) that is fitted around the liquid supplier 45. The protector 45a prevents the liquid absorbed by the liquid supplier 45 from leaking or evaporating. Each of the liquid supplier 45 and the protector 45a is made of a flexible material. The joint 46 secures the liquid application member 44 to the base plate 40. Accordingly, the liquid application member 44 keeps projecting from the base plate 40 toward the upper pressure plate 34 with the end of the liquid application member 44 facing downward when the liquid application member 44 is moved by the liquid-applier movement assembly 35.

A liquid applier shaft 562 provided with a drive transmission gear 562a is secured to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid-applier pivot motor 563. The liquid applier 31 can be rotated in the forward and reverse directions about the liquid applier shaft 562 on the base 48 by a driving force transmitted from the liquid-applier pivot motor 563 to the liquid applier shaft 562 via the output gear 563a and the drive transmission gear 562a.

The crimper 32 serving as a post-processing device sandwiches, with serrate upper crimping teeth 32a and serrate lower crimping teeth 32b, at least a part (in other words, the liquid application position) of the sheet bundle Pb to which liquid is applied by the liquid applier 31 to press and deform at least the part of the sheet bundle Pb. Thus, the crimper 32 binds the sheet bundle Pb. In the following description, such a binding way in which the upper crimping teeth 32a and the lower crimping teeth 32b sandwich and press the sheet bundle Pb to deform at least a part of the sheet bundle Pb may be referred to as “crimp binding.” In other words, the crimper 32 crimps and binds the sheet bundle Pb or performs the crimp binding on the sheet bundle Pb. In short, the crimper 32 binds the sheet bundle Pb without binding materials such as staples. The components of the crimper 32 such as the upper crimping teeth 32a and the lower crimping teeth 32b are disposed on a crimping frame 32c.

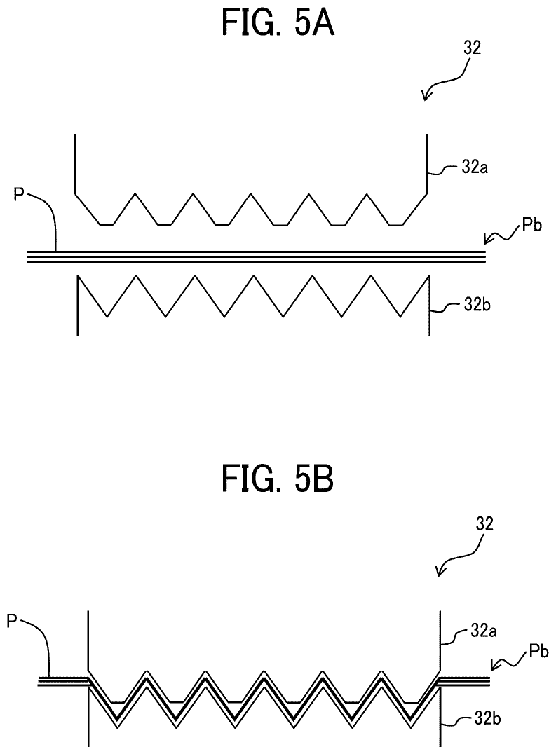

FIGS. 5A and 5B are schematic diagrams illustrating the configuration of the crimper 32.

As illustrated in FIGS. 5A and 5B, the crimper 32 includes a pair of binding teeth (i.e., the upper crimping teeth 32a and the lower crimping teeth 32b). The upper crimping teeth 32a and the lower crimping teeth 32b are disposed to face each other in the thickness direction of the sheet bundle Pb so as to sandwich the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The concave portions and the convex portions of the upper crimping teeth 32a are shifted from the concave portions and the convex portions of the lower crimping teeth 32b such that the upper crimping teeth 32a are engaged with the lower crimping teeth 32b.

The serrate upper crimping teeth 32a and lower crimping teeth 32b have inclined portions of any angle.

Shapes of an apex and a valley of the serrate shape are different between the upper crimping teeth 32a and the lower crimping teeth 32b. More particularly, a tooth height (distance from the apex to the valley) of the upper crimping teeth 32a is lower than a tooth height of the lower crimping teeth 32b. As a result, when the upper crimping teeth 32a and the lower crimping teeth 32b mesh with each other, the apex of the upper crimping teeth 32a and the valley of the lower crimping teeth 32b do not come into contact with each other. Therefore, the sheet P pressurized by the upper crimping teeth 32a and the lower crimping teeth 32b is crushed and stretched by inclined surfaces, and escapes into a gap between the apex of the upper crimping teeth 32a and the valley of the lower crimping teeth 32b. As a result, the sheet bundle Pb can be crimped (displacement is generated between sheets, and fibers are tangled to adhere) by the inclined surfaces alone, and the crimp binding can be efficiently performed.

The upper crimping teeth 32a and the lower crimping teeth 32b are brought into contact with and separated from each other by the driving force of a contact-separation motor 32d illustrated in FIG. 10. In the process of supplying the sheets P of the sheet bundle Pb to the internal tray 22, the upper crimping teeth 32a and the lower crimping teeth 32b are separated from each other as illustrated in FIG. 5A. When all the sheets P of the sheet bundle Pb are placed on the internal tray 22, the upper crimping teeth 32a and the lower crimping teeth 32b are engaged with each other to press and deform the sheet bundle Pb in the thickness direction as illustrated in FIG. 5B. As a result, the sheet bundle Pb that has been placed on the internal tray 22 is crimped and bound. The sheet bundle Pb thus crimped and bound is output to the output tray 26 by the conveyance roller pair 15.

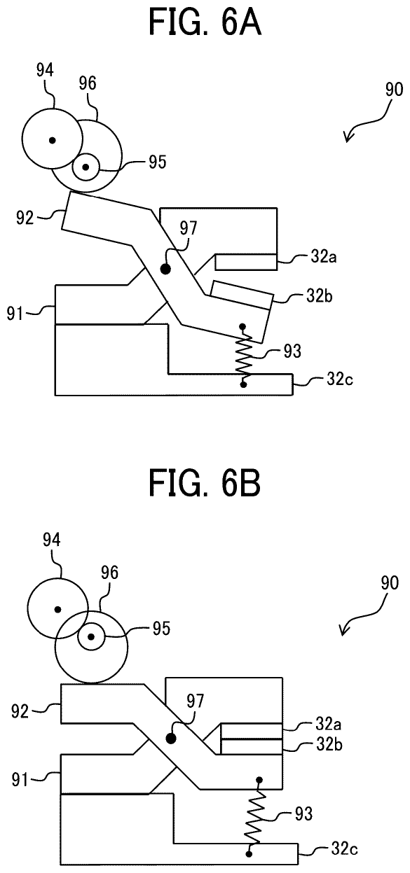

FIGS. 6A and 6B are diagrams illustrating a contact-separation mechanism 90 that causes the upper crimping teeth 32a and the lower crimping teeth 32b to be in contact with and separated from each other.

The contact-separation mechanism 90 is a mechanism that causes the upper crimping teeth 32a and the lower crimping teeth 32b to be in contact with and separated from each other by using a driving force of the contact-separation motor 32d. For example, as illustrated in FIGS. 6A and 6B, the contact-separation mechanism 90 mainly includes an upper arm 91, a lower arm 92, a coil spring 93 (bias member), a driving gear 94, a driven gear 95, and an eccentric cam 96.

The upper arm 91 is secured to the crimping frame 32c. The upper arm 91 supports the upper crimping teeth 32a. The lower arm 92 is rotatably supported by the upper arm 91 around a rotation shaft 97. The lower arm 92 supports the lower crimping teeth 32b at one end (an end on a side facing the upper crimping teeth 32a). By the lower arm 92 rotating around the rotation shaft 97, the upper crimping teeth 32a and the lower crimping teeth 32b come into contact with and separate from each other. The coil spring 93 biases the lower arm 92 in a direction of separating the upper crimping teeth 32a and the lower crimping teeth 32b. The driving gear 94 is rotated by a driving force of the contact-separation motor 32d. The driven gear 95 is meshed with the driving gear 94. The eccentric cam 96 is coupled to the driven gear 95 at a position deviated from a center, and rotates integrally with the driven gear 95. An outer peripheral surface of the eccentric cam 96 is in contact with another end of the lower arm 92 (an end opposite to a side supporting the lower crimping teeth 32b with the rotation shaft 97 interposed therebetween).

When the eccentric cam 96 is in the state of FIG. 6A, the upper crimping teeth 32a and the lower crimping teeth 32b are separated from each other by the bias force of the coil spring 93. When the eccentric cam 96 rotates from the state of FIG. 6A, the lower arm 92 rotates in a direction in which the upper crimping teeth 32a and the lower crimping teeth 32b come into contact with n each other, against the bias force of the coil spring 93. When the eccentric cam 96 is in the state of FIG. 6B, the upper crimping teeth 32a and the lower crimping teeth 32b mesh with each other. When the eccentric cam 96 rotates from the state of FIG. 6B, the lower arm 92 rotates in a direction of separating the upper crimping teeth 32a and the lower crimping teeth 32b from each other with the bias force of the coil spring 93.

The configuration of the crimper 32 as a crimping assembly is not limited to the configuration according to some aspects of the embodiment described above, provided that the upper crimping teeth 32a and the lower crimping teeth 32b of the crimping assembly are engaged with each other. For example, the configuration may be a crimping assembly of a link mechanism type (for example, disclosed in Japanese Patent No. 6057167) that performs the crimping and separation operation of the upper crimping teeth 32a and the lower crimping teeth 32b by using a link mechanism and a drive source that performs forward rotation alone or forward and reverse rotation, or may be a crimping assembly of a linear motion type that linearly performs the crimping (approaching) and separation operation of the upper crimping teeth 32a and the lower crimping teeth 32b by using a screw mechanism that converts rotational motion of a drive source in forward and reverse directions into linear reciprocating motion.

A crimper shaft 54 provided with a drive transmission gear 54a is secured to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

As illustrated in FIG. 3, the edge binder 25 includes an edge-binder movement assembly 47. The edge-binder movement assembly 47 moves the edge binder 25, specifically, the liquid applier 31 and the crimper 32, in the main scanning direction along a downstream end, in the conveyance direction, of the sheet P placed on the internal tray 22. The edge-binder movement assembly 47 includes, for example, the base 48, a guide shaft 49, the edge-binder movement motor 50, and a driving force transmission assembly 551.

The liquid applier 31 and the crimper 32 are attached to the base 48 so as to be adjacent to each other in the main scanning direction. The guide shaft 49 extends in the main scanning direction at a position downstream from the internal tray 22 in the conveyance direction of the sheet P. The guide shaft 49 supports the base 48 movably in the main scanning direction. The edge-binder movement motor 50 generates a driving force to move the edge binder 25. The driving force transmission assembly 551 transmits the driving force of the edge-binder movement motor 50 to the base 48 via pullies 551a and 551b and a timing belt 551c. As a result, the liquid applier 31 and the crimper 32 integrated by the base 48 move in the main scanning direction along the guide shaft 49.

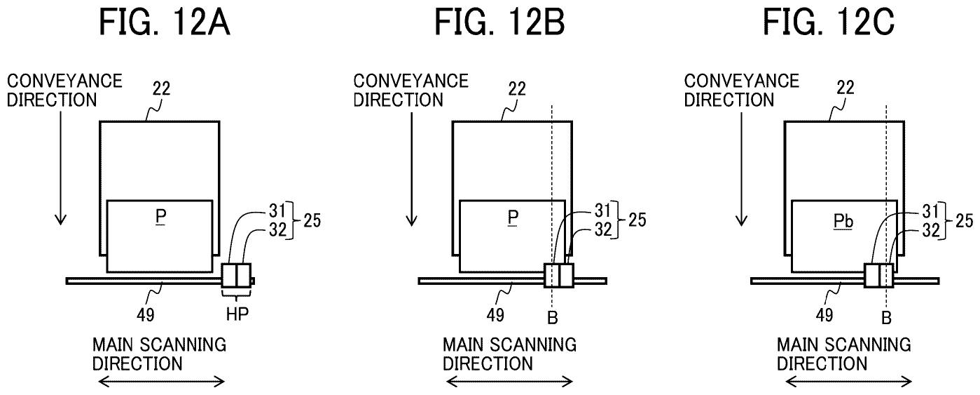

In other words, as illustrated in FIG. 12A, a standby position HP is away in the width direction from the sheet P placed on the internal tray 22. As illustrated in FIGS. 12B and 12C, the liquid applier 31 and the crimper 32 are movable along a guide shaft 49 to a position where the liquid applier 31 and the crimper 32 can face the sheet P placed on the internal tray 22 in the thickness direction of the sheet P.

The edge-binder movement motor 50 according to the present embodiment is, for example, a servo motor that can stop the edge binder 25 at a target position (i.e., a binding position B) without returning the edge binder 25 to an origin position (for example, the standby position HP described later) each time the edge binder 25 is moved.

The post-processing apparatus 3 further includes an edge-binding standby position sensor 51 (for example, a light shielding optical sensor, see FIG. 10) that detects that the edge binder 25 has reached the standby position HP (see FIGS. 12A to 12C), and an encoder sensor 541 (see FIG. 10) attached to an output shaft of the edge-binder movement motor 50. A controller 100, which will be described later, detects the arrival of the edge binder 25 at the standby position HP, based on a detection result of the edge-binding standby position sensor 51. The controller 100 also counts pulse signals output from the encoder sensor 541 to ascertain the current position of the edge binder 25 moved from the standby position HP.

However, a specific method of stopping the edge binder 25 at the target position without returning the edge binder 25 to the origin position is not limited to the aforementioned example. As another example, the post-processing apparatus 3 may include a sensor that detects the arrival of the edge binder 25 at a given target position determined in advance.

A description is given below of a modification of the edge binder 25 described above.

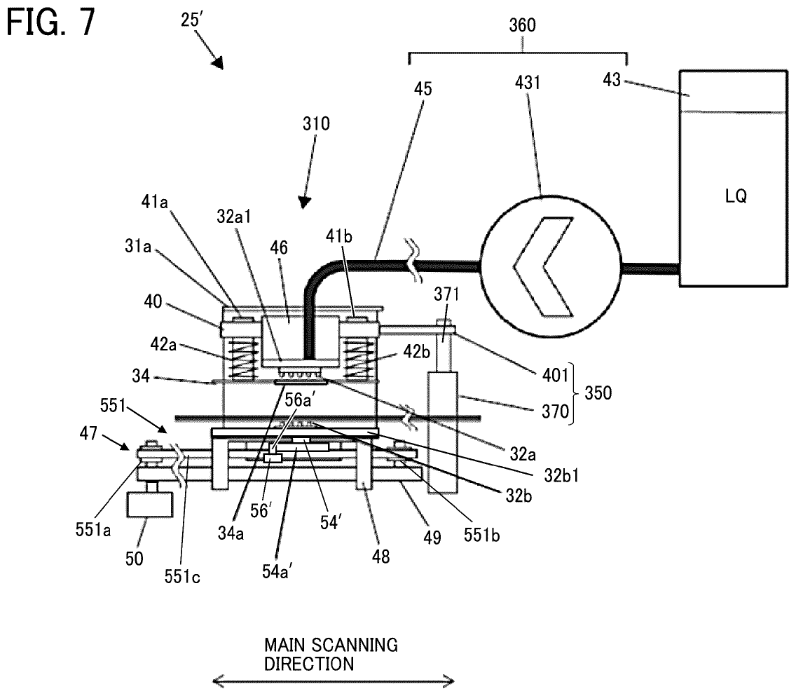

Specifically, referring now to FIGS. 7 to 9A to 9C, a description is given of an edge binder 25′ as a post-processing device and as a modification of the edge binder 25 included in the post-processing apparatus 3. The edge binder 25′ is different from the edge binder 25 described above in that the liquid applier 31 and the crimper 32 are integrated as a single unit.

In the following description, components like the components of the edge binder 25 described above are denoted by like reference numerals, and redundant descriptions thereof may be omitted unless otherwise necessary.

FIG. 7 is a schematic view of the edge binder 25′ viewed from the upstream side in the conveyance direction.

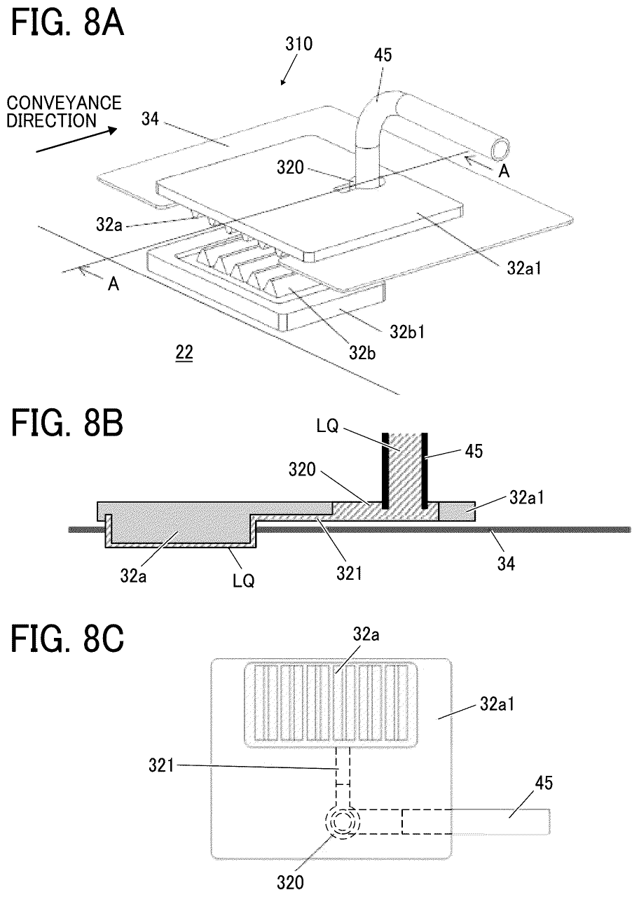

FIG. 8A is a perspective view of a liquid application crimper 310.

FIG. 8B is a cross-sectional view of the liquid application crimper 310 taken along line A-A in FIG. 8A.

FIG. 8C is a plan view of the upper crimping teeth 32a of FIG. 8A as viewed from a direction in which the lower crimping teeth 32b exist.

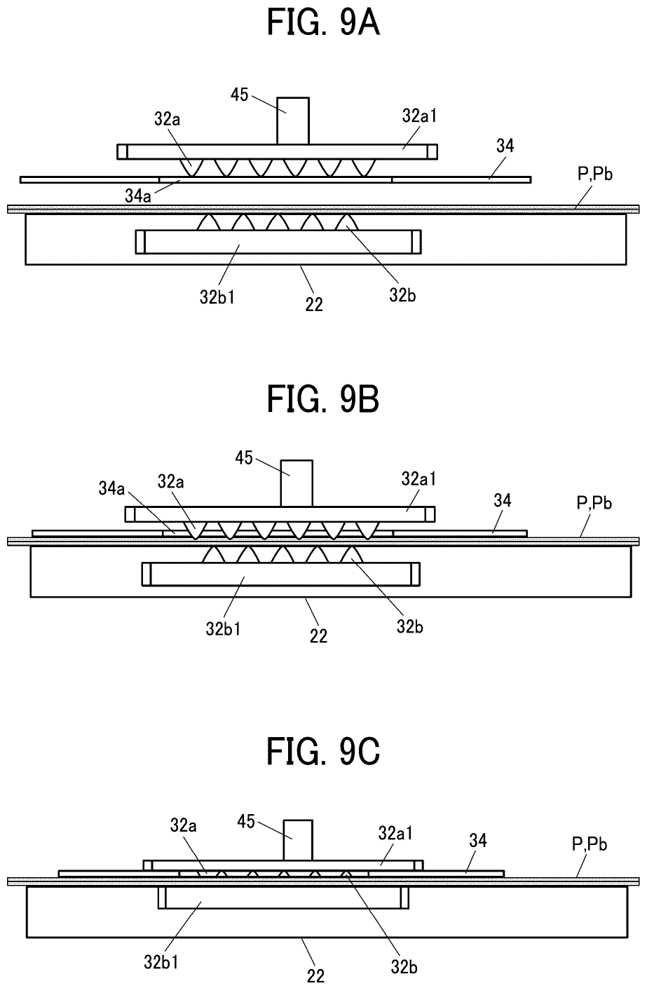

FIGS. 9A, 9B, and 9C illustrate a liquid application operation and a crimp binding operation performed by the liquid application crimper 310 and are schematic views of the liquid application crimper 310 viewed from the downstream side in the conveyance direction.

As illustrated in FIG. 7, the edge binder 25′ includes the liquid application crimper 310 in which the liquid applier 31 and the crimper 32 of the edge binder 25 according to the first embodiment are integrated as a single unit. The liquid application crimper 310 is disposed downstream from the internal tray 22 in the conveyance direction.

The liquid application crimper 310 applies liquid LQ stored in the liquid storage tank 43 to the sheet P or the sheet bundle Pb placed on the internal tray 22. The liquid application crimper 310 can be moved in the main scanning direction by the driving force that is transmitted from the edge-binder movement motor 50 to the base 48 by the driving force transmission assembly 551. The liquid application crimper 310 includes the upper pressure plate 34, the upper crimping teeth 32a, the lower crimping teeth 32b, a liquid application crimper movement assembly 350, and a liquid supply assembly 360. The components of the liquid application crimper 310 are held by the liquid application frame 31a and the base 48. A liquid-application-crimper shaft 54′ provided with a drive transmission gear 54a′ is secured to a bottom face of the liquid application frame 31a. The liquid-application-crimper shaft 54′ and the drive transmission gear 54a′ are held by the base 48 on which the liquid application frame 31a is disposed, so as to be rotatable in the forward and reverse directions. The drive transmission gear 54a′ meshes with an output gear 56a′ of a liquid-application-crimper pivot motor 56′. The liquid application crimper 310 can be rotated in the forward and reverse directions about the liquid-application-crimper shaft 54′ on the base 48 by a driving force transmitted from the liquid-application-crimper pivot motor 56′ to the liquid-application-crimper shaft 54′ via the output gear 56a′ and the drive transmission gear 54a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds an upper-crimping-teeth holder 32al and the upper crimping teeth 32a via the joint 46. The base plate 40 movably holds the upper pressure plate 34 via the columns 41a and 41b. The base plate 40 is attached to an end of a rod 371 of the electric cylinder 370 via a connecter 401.

The columns 41a and 41b have respective lower ends holding the upper pressure plate 34. The coil springs 42a and 42b are fitted around the columns 41a and 41b, respectively, between the base plate 40 and the upper pressure plate 34. The coil springs 42a and 42b bias the upper pressure plate 34 and the columns 41a and 41b in a direction away from the base plate 40.

The liquid supply assembly 360 includes the liquid storage tank 43, a liquid supply pump 431, and the liquid supplier 45. The liquid supply pump 431 supplies the liquid LQ via the liquid supplier 45 to a liquid reservoir 320 of the upper-crimping-teeth holder 32al as illustrated in FIG. 8A. The liquid supplier 45 is an elastic elongated member having a base end (proximal end) coupled to the liquid supply pump 431 and a distal end coupled to the liquid reservoir 320.

As illustrated in FIG. 8B, the upper crimping teeth 32a are integrated with the upper-crimping-teeth holder 32al. The upper-crimping-teeth holder 32al is provided with the liquid reservoir 320 and a liquid supply path 321 for supplying the liquid LQ stored in the liquid reservoir 320 to the upper crimping teeth 32a. The surface of the upper crimping teeth 32a is subjected to a hydrophilic treatment so that the liquid LQ that is supplied through the liquid supply path 321 uniformly spreads over the surface of the upper crimping teeth 32a. On the other hand, the portion of the upper-crimping-teeth holder 32al other than the upper crimping teeth 32a is subjected to a hydrophobic treatment so that the liquid LQ efficiently spreads over the surface of the upper crimping teeth 32a.

As illustrated in FIG. 7, the lower crimping teeth 32b are integrated with a lower-crimping-teeth holder 32b1, which is a part of the liquid application frame 31a. The lower crimping teeth 32b are attached to the base 48 via the lower-crimping-teeth holder 32b1.

A description is now given of the liquid application operation and the crimp binding operation by the liquid application crimper 310, with reference to FIGS. 9A to 9C.

In the process of supplying the sheet P to the internal tray 22, as illustrated in FIG. 9A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 9B, the upper pressure plate 34 first comes into contact with the sheet P, and then the upper crimping teeth 32a pass through the through hole 34a of the upper pressure plate 34 and come into contact with the sheet P. At this time, since the liquid LQ is spread over the surfaces of the upper crimping teeth 32a, bringing the upper crimping teeth 32a into contact with the sheet P allows the liquid to be applied to the liquid application position on the sheet P. When the liquid application to the liquid application position is completed, the electric cylinder 370 is extended to separate the upper crimping teeth 32a and the upper pressure plate 34 from the sheet P. The aforementioned contact and separation operation of the upper crimping teeth 32a and the upper pressure plate 34 with respect to the sheet P corresponds to the liquid application operation, which is repeated on the sheets P of the sheet bundle Pb.

In response to reaching the number of the sheets P of the sheet bundle Pb placed on the internal tray 22 to a predetermined number, the electric cylinder 370 is further contracted to move the upper crimping teeth 32a toward the lower crimping teeth 32b. Then, as illustrated in FIG. 9C, in a state in which the sheet bundle Pb is sandwiched between the upper crimping teeth 32a and the lower crimping teeth 32b, the upper crimping teeth 32a further moves toward the lower crimping teeth 32b. Thus, the upper crimping teeth 32a and the lower crimping teeth 32b press and deform the sheet bundle Pb to crimp and bind the sheet bundle Pb (crimp binding operation).

A description is given of a control block of the post-processing apparatus 3.

FIG. 10 is a schematic block diagram illustrating a hardware configuration of the post-processing apparatus 3.

As illustrated in FIG. 10, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are coupled to each other via a common bus 109.

The CPU 101 is an arithmetic unit and controls the operation of the overall operation of the post-processing apparatus 3.

The RAM 102 is a volatile storage medium that allows data to be read and written at high speed. The CPU 101 uses the RAM 102 as a working area for data processing.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

The post-processing apparatus 3 processes, by an arithmetic function of the CPU 101, e.g., a control program stored in the ROM 103 and an information processing program (or application program) loaded into the RAM 102 from a storage medium such as the HDD 104. Such processing configures a software control device including various functional modules of the post-processing apparatus 3. The software control device thus configured cooperates with hardware resources of the post-processing apparatus 3 to construct functional blocks that implement functions of the post-processing apparatus 3. In other words, the CPU 101, the RAM 102, the ROM 103, and the HDD 104 construct the controller 100 (corresponding to a control device) that controls the operation of the post-processing apparatus 3.

The I/F 105 is an interface that couples the conveyance roller pairs 10, 11, 14, and 15, the switching plate 20, the side fences 24L and 24R, the contact-separation motor 32d, the crimper pivot motor 56, the liquid-applier movement motor 37, the liquid-applier pivot motor 563, the edge-binder movement motor 50, a stapling-unit drive motor 62d, a stapler pivot motor 82, a stapling-unit movement motor 80, the movement sensor 40a, the liquid amount sensor 43a, the edge-binding standby position sensor 51, the encoder sensor 541, and a control panel 110 to the common bus 109. The controller 100 controls, via the I/F 105, the operations of the conveyance roller pairs 10, 11, 14, and 15, the switching plate 20, the side fences 24L and 24R, the contact-separation motor 32d, the crimper pivot motor 56, the liquid-applier movement motor 37, the liquid-applier pivot motor 563, the edge-binder movement motor 50, the stapling-unit drive motor 62d, the stapler pivot motor 82, and the stapling-unit movement motor 80.

The controller 100 acquires detection results from the movement sensor 40a, the liquid amount sensor 43a, the edge-binding standby position sensor 51, and the encoder sensor 541. Although FIG. 10 illustrates the components related to the stapling unit 155 and the edge binder 25 that executes the edge binding, the components related to the saddle stitcher 28 that executes the saddle stitching are controlled by the controller 100 like the components related to the stapling unit 155 and the edge binder 25 that executes the edge binding.

As illustrated in FIG. 1, the image forming apparatus 2 includes the control panel 110. The control panel 110 includes an operation unit that receives instructions input by an operator and a display serving as a notifier that notifies the operator of information. Thus, the control panel 110 serves as an input device. The control panel includes, for example, physical input buttons and a touch screen superimposed on a display. The control panel 110 acquires information from the operator through the operation device and provides the operator with information through the display. A specific example of the notification unit is not limited to the display and may be a light emitting diode (LED) lamp or a speaker. The operator includes a so-called “operator” who is in charge of manufacturing the post-processing apparatus 3 or the maintenance of the post-processing apparatus 3 and a so-called “user” who uses the post-processing apparatus 3. The post-processing apparatus 3 may include the control panel 110 similar to the above-described control panel 110 of the image forming apparatus 2.

A description is given of a binding process according to an embodiment of the present disclosure.

A description is given below of the binding process executed by the edge binder 25 included in the post-processing apparatus 3.

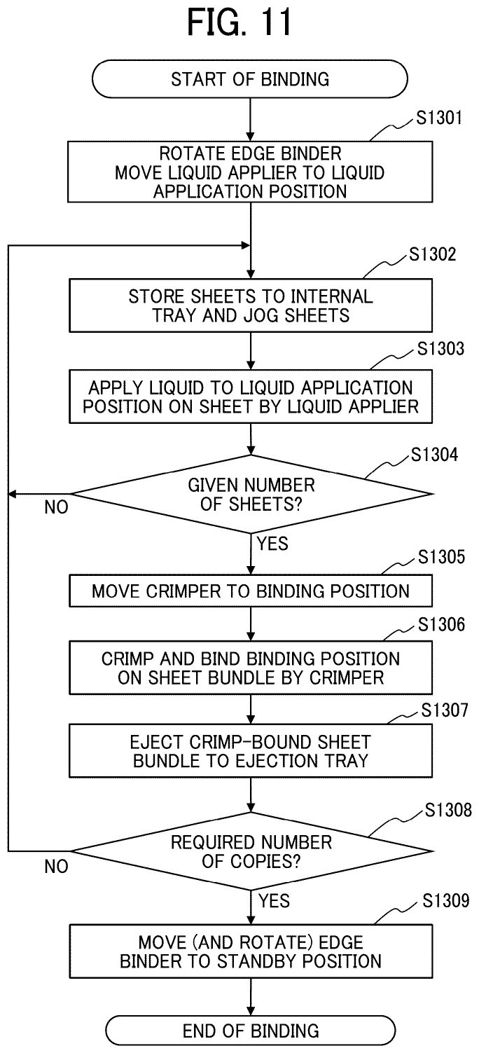

FIG. 11 is a flowchart of a binding process according to an embodiment of the present disclosure.

FIGS. 12A, 12B, and 12C are diagrams illustrating the positions of the liquid applier 31 and the crimper 32 during the binding process. FIGS. 12A, 12B, and 12C do not illustrate changes in the postures of the liquid applier 31 and the crimper 32.

The liquid application position to which the liquid is applied on the sheet P or the sheet bundle Pb by the liquid applier 31 corresponds to the binding position of the sheet bundle Pb to be crimped and bound by the crimper 32. For this reason, in the following description, the liquid application position and the binding position are denoted by the same reference sign.

For example, the controller 100 starts the binding process illustrated in FIG. 11 when the controller 100 acquires an instruction to execute the binding process from the image forming apparatus 2. In the following description, the instruction to execute the binding process may be referred to as a “binding command.”

The binding command includes, for example, the type of the sheet P (i.e., information affecting the spread of liquid, such as material and thickness), the number of sheets P of the sheet bundle Pb, the number of sheet bundles Pb to be bound, the binding position on the sheet bundle Pb, and the binding posture of the edge binder 25. In the following description, the number of sheets P of the sheet bundle Pb may be referred to as “given number” while the number of sheet bundles Pb to be bound may be referred to as “requested number of copies.” The liquid applier 31 and the crimper 32 are in a parallel binding posture and at the standby position HP as illustrated in FIG. 12A at the start of the binding process. As described above, the standby position HP is away in the width direction from the sheet P placed on the internal tray 22.

When the posture that is instructed by the binding command is the “oblique binding posture,” the controller 100 drives the liquid-applier pivot motor 563 and the crimper pivot motor 56 to rotate the liquid applier 31 and the crimper 32 of the edge binder 25 into the oblique binding posture. Alternatively, when the posture that is instructed by the binding command is the “oblique binding posture,” the crimper 32 alone may be rotated to the oblique binding posture while the liquid applier 31 may not be rotated. In this case, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture,” the controller 100 omits the aforementioned operation of rotating the liquid applier 31 and the crimper 32 of the edge binder 25 to the oblique binding posture. In step S1301, as illustrated in FIG. 12B, the controller 100 also drives the edge-binder movement motor 50 to move the edge binder 25 in the main scanning direction so that the liquid applier 31 faces the liquid application position B instructed by the binding command. Note that the controller 100 executes the operation of step S1301 before a first sheet P is conveyed to the internal tray 22 by the conveyance roller pairs 10, 11, 14, and 15.

Subsequently, in step S1302, the controller 100 rotates the conveyance roller pairs 10, 11, 14, and 15 to accommodate the sheet P on which an image is formed by the image forming apparatus 2 in the internal tray 22. In step S1302, the controller 100 also moves the side fences 24L and 24R to align the position, in the main scanning direction, of the sheet bundle Pb placed on the internal tray 22. In short, the controller 100 performs so-called jogging.

Subsequently, in step S1303, the controller 100 causes the liquid applier 31 facing the liquid application position B to apply liquid to the liquid application position B on the sheet P, which has been placed on the internal tray 22 in the immediately preceding step S1302, based on liquid application control data adjusted in advance. In other words, the controller 100 drives the liquid-applier movement motor 37 to bring the liquid application member 44 into contact with the liquid application position B on the sheet P placed on the internal tray 22 as illustrated in FIG. 12B.

More particularly, the controller 100 retrieves, from the HDD 104, an amount of liquid to be applied, which is represented by a liquid application level corresponding to the type of the sheet P indicated by the binding command. Then, in step S1303, the controller 100 causes the liquid applier 31 to apply the retrieved amount of liquid to the binding position on the sheet P. In other words, the controller 100 causes the liquid applier 31 to apply the liquid to the binding position on the sheet P placed on the internal tray 22, by the amount input through a screen for setting the amount of liquid to be applied.

Subsequently, in step S1304, the controller 100 determines whether the number of sheets P accommodated in the internal tray 22 has reached the given number instructed by the binding command. When the controller 100 determines that the number of sheets P accommodated in the internal tray 22 has not reached the given number (NO in step S1304), the controller 100 executes the operations of steps S1302 and S1303 again. In other words, the controller 100 executes the operations of steps S1302 and S1303 each time the sheet P is conveyed to the internal tray 22 by the conveyance roller pairs 10, 11, 14, and 15. Note that the liquid applier 31 may apply liquid to all or some of the sheets P of the sheet bundle Pb. For example, the controller 100 may cause the liquid applier 31 to apply the liquid to the sheet P at intervals of one in every “n” sheets.

In contrast, when the controller 100 determines that the number of sheets P accommodated in the internal tray 22 has reached the given number (YES in step S1304), in step S1305, the controller 100 drives the edge-binder movement motor 50 to move the edge binder 25 in the main scanning direction so that the crimper 32 faces the binding position B as illustrated in FIG. 12C.

Subsequently, in step S1306, the controller 100 causes the crimper 32 to perform crimp binding on the sheet bundle Pb placed on the internal tray 22. In step S1307, the controller 100 causes the conveyance roller pair 15 to output the sheet bundle Pb thus crimped and bound by the crimper 32 to the output tray 26. Specifically, the controller 100 drives the contact-separation motor 32d to cause the upper crimping teeth 32a and the lower crimping teeth 32b to sandwich the binding position B on the sheet bundle Pb placed on the internal tray 22. The sheet bundle Pb is pressed and deformed between the upper crimping teeth 32a and the lower crimping teeth 32b. Thus, the crimper 32 crimps and binds the sheet bundle Pb. Then, the controller 100 rotates the conveyance roller pair 15 to output the sheet bundle Pb thus crimped and bound to the output tray 26.

The sheet bundle Pb that is placed on the internal tray 22 has a crimping area (corresponding to the binding position B) sandwiched between the upper crimping teeth 32a and the lower crimping teeth 32b in step S1306. The crimping area overlaps a liquid application area (corresponding to the liquid application position B) with which the end of the liquid application member 44 comes into contact in step S1303. In other words, the crimper 32 crimps and binds an area to which the liquid has been applied by the liquid applier 31 on the sheet bundle Pb placed on the internal tray 22. The crimping area that is sandwiched by the upper crimping teeth 32a and the lower crimping teeth 32b may completely or partially overlaps the liquid application area contacted by the end of the liquid application member 44, to obtain a sufficient binding strength.

Subsequently, in step S1308, the controller 100 determines whether the number of sheet bundles Pb thus output has reached the requested number of copies indicated by the binding command. When the controller 100 determines that the number of sheet bundles Pb thus output has not reached the requested number of copies (NO in step S1308), the controller 100 executes the operations of step S1302 and the following steps again. In other words, when NO in step S1308, the controller 100 repeats the operations of steps S1302 to S1307 until the number of sheet bundles Pb output to the output tray 26 reaches the requested number of copies.

By contrast, when the controller 100 determines that the number of sheet bundles Pb output to the output tray 26 has reached the requested number of copies (YES in step S1308), in step S1309, the controller 100 drives the edge-binder movement motor 50 to move the edge binder 25 to the standby position HP as illustrated in FIG. 12A. When the posture that is instructed by the binding command is the “oblique binding posture,” in step S1309, the controller 100 also drives the liquid-applier pivot motor 563 and the crimper pivot motor 56 to rotate the liquid applier 31 and the crimper 32 into the parallel binding posture. By contrast, when the posture that is instructed by the binding command is the “parallel binding posture,” the controller 100 omits the aforementioned operation of rotating the liquid applier 31 and the crimper 32 to the parallel binding posture. As a result, the liquid applier 31 and the crimper 32 return to the standby position HP illustrated in FIG. 12A. Note that, in steps S1301 and S1309, the execution order of the movement in the main scanning direction and the rotation in the forward and reverse directions of the liquid applier 31 and the crimper 32 is not limited to the aforementioned order and may be reversed.

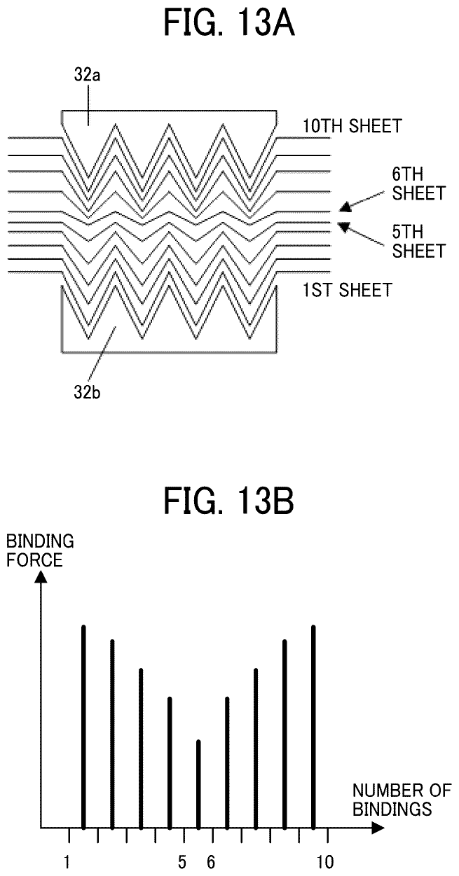

FIGS. 13A and 13B are diagrams illustrating a binding force in a case where the sheet bundle Pb is crimped and bound.

As illustrated in FIG. 13A, when 10 (N=10) sheets P are crimped and bound by the upper crimping teeth 32a and the lower crimping teeth 32b, outer sheets P (for example, the first sheet, the second sheet, the ninth sheet, and the tenth sheet) deform relatively largely, while a deformation amount of inner sheets P (for example, the fifth sheet and the sixth sheet) is relatively small.

Accordingly, as illustrated in FIG. 13B, the binding force applied to each of the sheets P (first to tenth sheets) increases toward the outside and decreases toward the inside. As a result, there is a possibility that the fifth and sixth sheets P having weak crimping strength are peeled off, and the crimped and bound sheet bundle Pb is separated afterwards. This becomes more noticeable as the number of sheets P (=N) included in the sheet bundle Pb increases.

A description is given below of a binding number determination process.

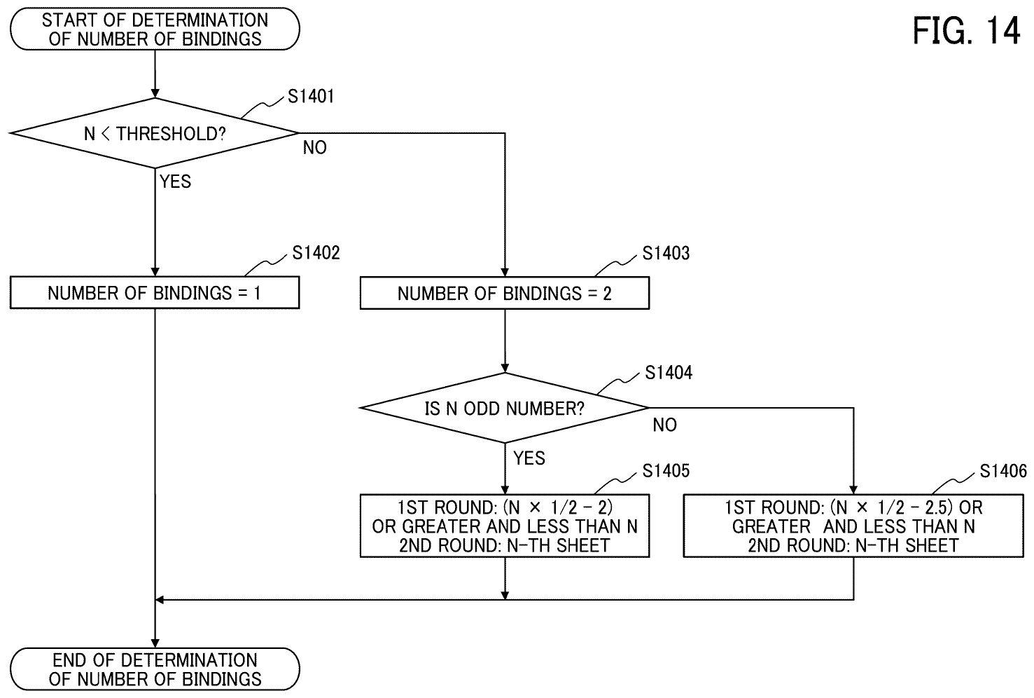

FIG. 14 is a flowchart of a binding number determination process.

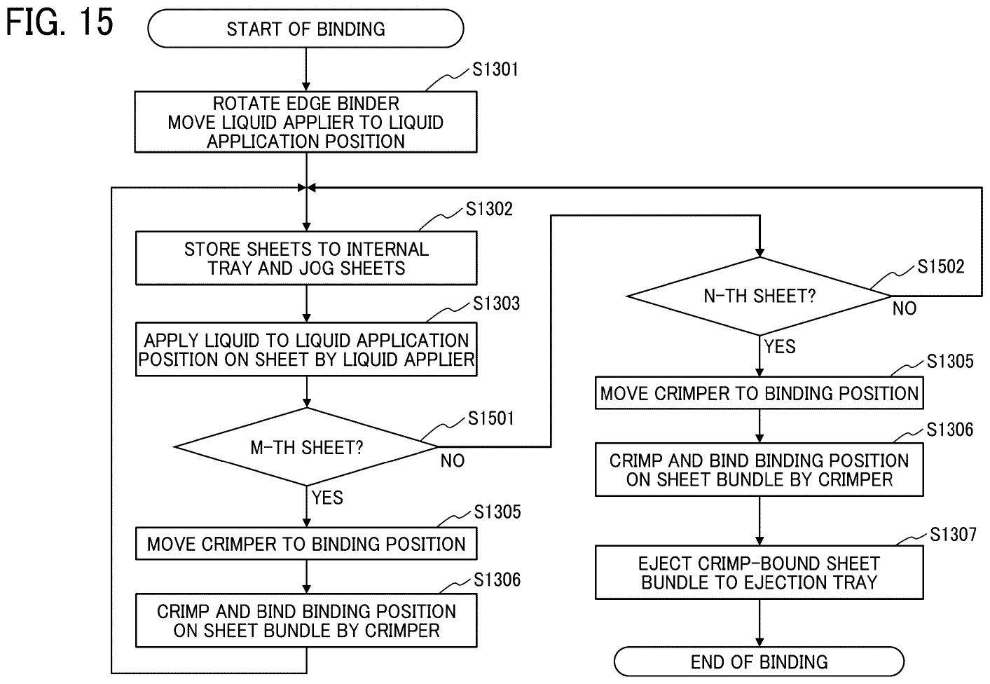

The binding number determination process is a process of determining the number of times of crimp binding and an execution timing when the sheet bundle Pb constructed of N sheets P is crimped and bound. In the present embodiment, the number N of sheets P included in the sheet bundle Pb is 10, but the value of N is not limited thereto. For example, upon acquiring the binding command, the controller 100 executes the binding number determination process illustrated in FIG. 14 prior to executing the binding process illustrated in FIG. 11 or 15.

First, in step S1401, the controller 100 compares the given number N indicated by the binding command with a predetermined threshold. The threshold is a limit number of sheets that can be appropriately bound by one time of the crimp binding, and is, for example, a value appropriately determined according to a maximum torque (in other words, the binding force of the crimper 32) of the contact-separation motor 32d.

Then, in a case where the given number N is smaller than the threshold (YES in step S1401), the controller 100 determines the number of times of binding to be 1 in step S1402, and ends the binding number determination process. In this case, the controller 100 causes the crimper 32 to perform the crimp binding exclusively at the time point when N sheets P are placed on the internal tray 22 in the binding process illustrated in FIG. 11. In other words, the controller 100 does not cause the crimper 32 to perform the crimp binding until the N sheets P are placed on the internal tray 22. The procedure of the binding process in this case is as described with reference to FIG. 11.

On the other hand, when the given number N of sheets is equal to or larger than the threshold (NO in step S1401), the controller 100 determines the number of times of binding to be 2 in step S1403. In other words, the controller 100 causes the crimper 32 to perform the crimp binding at the time point (first time) when M (<N) sheets P are placed on the internal tray 22 and the time point (second time) when N sheets P are placed on the internal tray 22. In the example of FIG. 14, a case where the crimp binding is performed once and a case where the crimp binding is performed twice are described. However, when the given number N is still larger, the crimp binding may be performed three times or more.

Then, the controller 100 determines an execution timing of the first crimp binding (in other words, the value of M). On the other hand, an execution timing of the second crimp binding is the time point when N sheets P are placed on the internal tray 22. In step S1404, the controller 100 determines whether the given number N is an even number or an odd number.

When the given number N is an even number (YES in step S1404), in step S1405, the controller 100 determines the value of M within a range of (N×½−2) or more and less than N. For example, when the given number N is 10, the value of M is in the range of 3 to 9. More preferably, the controller 100 determines the value of M to be (N×½+1) (in this case, M=6). On the other hand, in a case where the given number N is an odd number (NO in step S1404), in step S1406, the controller 100 determines the value of M within a range of (N×½−2.5) or more and less than N. For example, when the given number N is 11, the value of M is in the range of 3 to 10. More preferably, the controller 100 determines the value of M to be (N×½+1.5) (in this case, M=7).

A description is given below of a binding process of performing crimp binding twice.

FIG. 15 is a flowchart of a binding process of performing crimp binding twice.

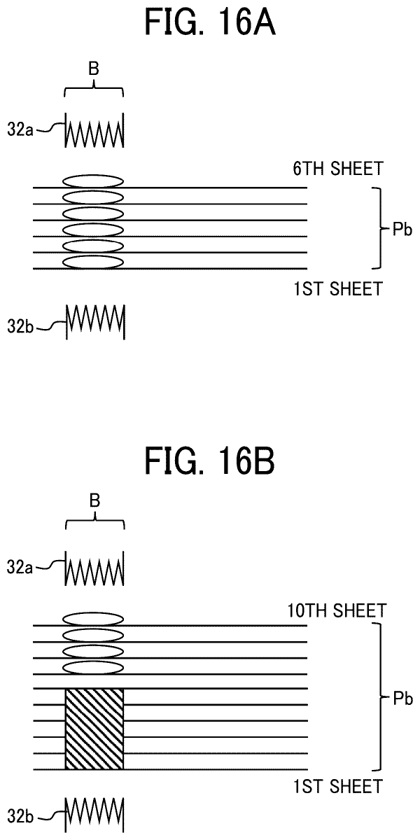

FIGS. 16A and 16B are diagrams illustrating a state of the sheet bundle Pb in a case of applying liquid to the same binding position B.

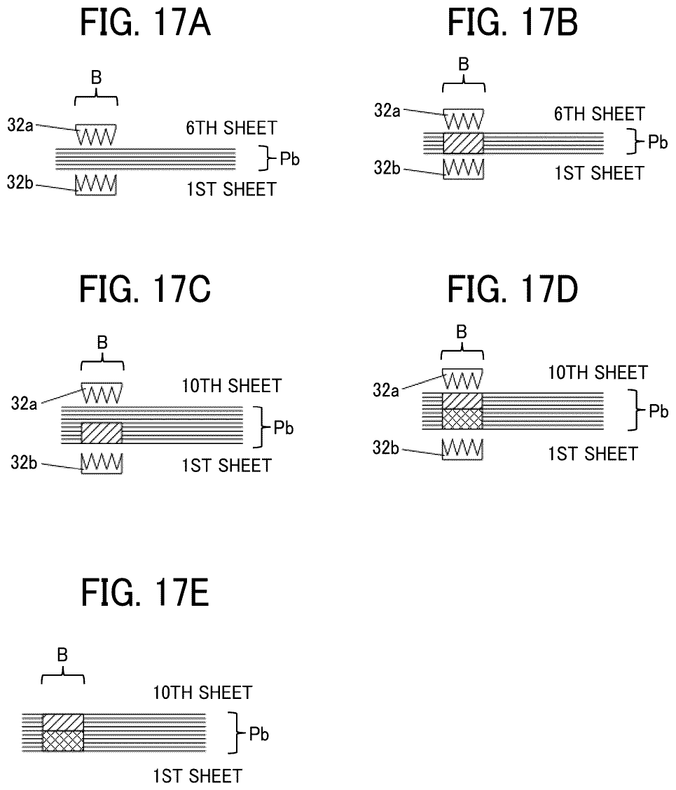

FIGS. 17A, 17B, 17C, 17D, and 17E are diagrams illustrating a state of the sheet bundle Pb in a case of binding twice at the same binding position B.

The controller 100 executes the binding process illustrated in FIG. 15 when the number of times of binding is determined to be 2 in the binding number determination process. Hereinafter, the process of FIG. 15 will be described with M=6 and N=10. However, the values of M and N are not limited thereto.

In FIG. 15, the processes of steps S1501 to S1502 are added to the binding process illustrated in FIG. 11. In addition, the same step numbers are assigned to the processes common to the processes in FIG. 11, and the description thereof will be omitted. Furthermore, although steps S1308 to S1309 in FIG. 11 are omitted in FIG. 15, these processes may be executed.

First, the controller 100 sequentially executes the processes of steps S1302 to S1303 on the first to sixth sheets P. As a result, as indicated by ellipses in FIG. 16A, the liquid is applied to the binding position B of each of the first to sixth sheets P by the liquid applier 31. However, the controller 100 does not need to apply the liquid to all the first to sixth sheets P. In other words, it suffices that the controller 100 causes the liquid applier 31 to apply the liquid to the binding position B of at least one of the first to sixth sheets P.

Subsequently, at the time point when the sixth sheet P is placed on the internal tray 22 (YES in step S1501), the controller 100 executes the processes of steps S1305 to S1306 on the six sheets P placed on the internal tray 22. In other words, in step S1306, as illustrated in FIGS. 17A and 17B, the controller 100 causes the crimper 32 to perform the crimp binding at the binding position B of the six sheets P placed on the internal tray 22.

Subsequently, the controller 100 sequentially executes the processes of steps S1302 to S1303 on the seventh to tenth sheets P placed on the internal tray 22 so as to overlap with the six sheets P crimped and bound. As a result, as indicated by ellipses in FIG. 16B, the liquid is applied to the binding position B of each of the seventh to tenth sheets P by the liquid applier 31. However, the controller 100 does not need to apply the liquid to all the seventh to tenth sheets P. In other words, it suffices that the controller 100 causes the liquid applier 31 to apply the liquid to the binding position B of at least one of the seventh to tenth sheets P.

Then, at the time point when the tenth sheet P is placed on the internal tray 22 (YES in step S1502), the controller 100 executes the processes of steps S1305 to S1307 on the 10 sheets P placed on the internal tray 22. In other words, in step S1306, as illustrated in FIGS. 17C to 17E, the controller 100 causes the crimper 32 to perform the crimp binding at the binding position B of the 10 sheets P placed on the internal tray 22. Then, in step S1307, the controller 100 outputs the sheet bundle Pb subjected to the crimp binding twice at the binding position B to the output tray 26.

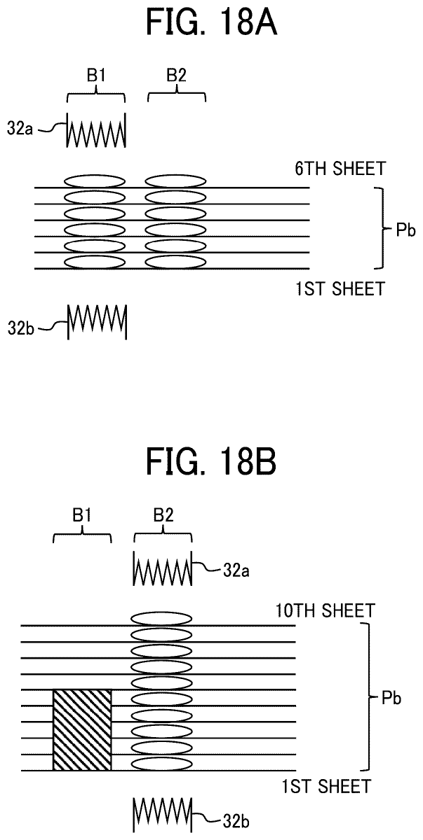

As described above, in the examples of FIGS. 16A, 16B, 17A, 17B, 17C, 17D, and 17E, when the sheet P is viewed from the thickness direction, the liquid is applied by the liquid applier 31 to the same position (in other words, the same binding position B) on the sheet P in step S1303, and the crimp binding is performed by the crimper 32 in step S1306. However, the controller 100 may perform the first crimp binding and the second crimp binding at different binding positions B1 and B2. Hereinafter, with reference to FIGS. 18A and 18B to 20A to 20D, an example in which the crimp binding is performed at the different binding positions B1 and B2 will be described.

FIGS. 18A and 18B are diagrams illustrating a state of the sheet bundle Pb in a case of applying liquid to the different binding positions B1 and B2.

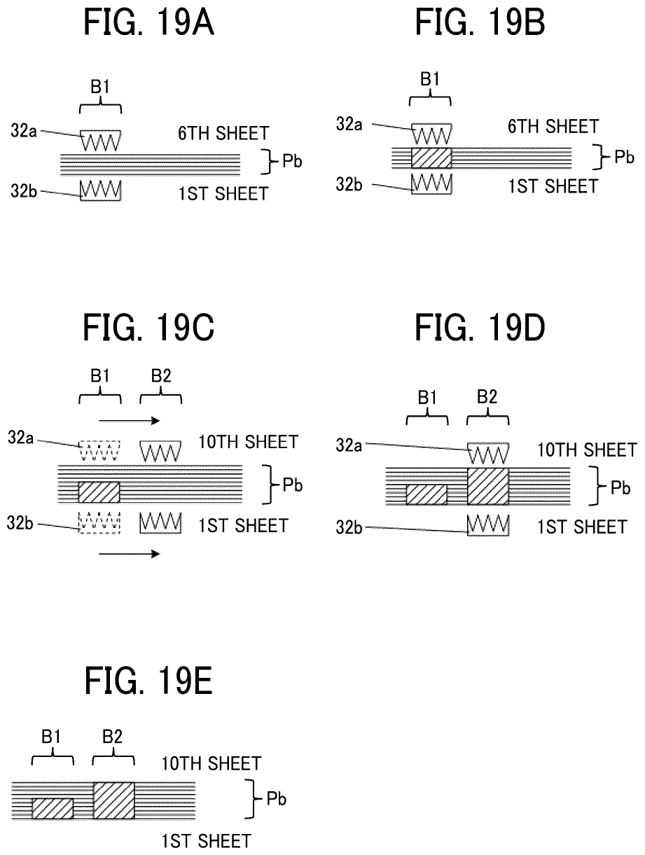

FIGS. 19A, 19B, 19C, 19D, and 19E are diagrams illustrating a state of the sheet bundle Pb in a case of binding at the different binding positions B1 and B2.

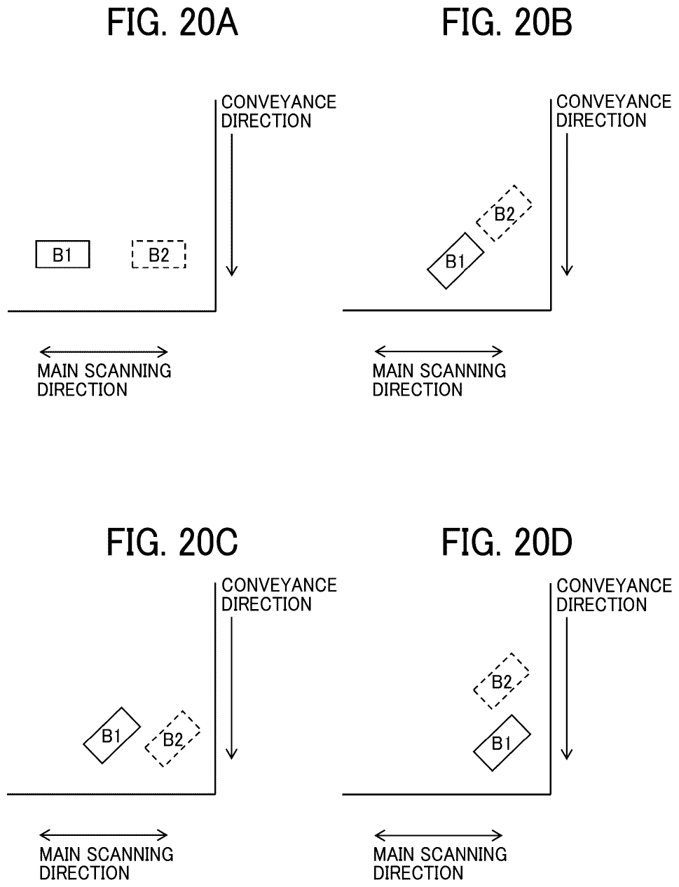

FIGS. 20A, 20B, 20C, and 20D are diagrams illustrating variations of the binding positions B1 and B2.

The binding positions B1 and B2 are positions that do not overlap with each other on the sheet P (in other words, different positions) when the sheet P is viewed from the thickness direction. The binding position B1 is an example of a first binding position, and the binding position B2 is an example of a second binding position.

First, the controller 100 sequentially executes the processes of steps S1302 to S1303 on the binding positions B1 and B2 of the first to sixth sheets P. In other words, in step S1303, as illustrated in FIG. 18A, the controller 100 causes the liquid applier 31 to apply the liquid to the binding position B1 of at least one of the first to sixth sheets P. On the other hand, in step S1303, the controller 100 may or may not cause the liquid applier 31 to apply the liquid to the binding position B2 of at least one of the first to sixth sheets P.

Then, at the time point when the sixth sheet P is placed on the internal tray 22 (YES in step S1501), the controller 100 executes the processes of steps S1305 to S1306 on the six sheets P. In other words, in step S1306, as illustrated in FIGS. 19A to 19B, the controller 100 causes the crimper 32 to perform the crimp binding at the binding position B1 of the six sheets P placed on the internal tray 22.

Subsequently, the controller 100 sequentially executes the processes of steps S1302 to S1303 on the seventh to tenth sheets P placed on the internal tray 22 so as to overlap with the six sheets P crimped and bound. In other words, in step S1303, as illustrated in FIG. 18B, the controller 100 causes the liquid applier 31 to apply the liquid to the binding position B2 of at least one of the seventh to tenth sheets P. In other words, no liquid is applied to the binding position B1 of the seventh to tenth sheets P.

Subsequently, at the time point when the tenth sheet P is placed on the internal tray 22 (YES in step S1502), the controller 100 executes the processes of steps S1305 to S1306 on the 10 sheets P placed on the internal tray 22. In other words, in step S1306, as illustrated in FIGS. 19C to 19E, the controller 100 causes the crimper 32 to perform the crimp binding at the binding position B2 of the 10 sheets P placed on the internal tray 22. Then, in step S1307, the controller 100 outputs the sheet bundle Pb subjected to the crimp binding once each at the binding positions B1 and B2 to the output tray 26.

As illustrated in FIGS. 20A and 20C, the binding positions B1 and B2 may be shifted in the main scanning direction. As illustrated in FIG. 20D, the binding positions B1 and B2 may be shifted in the conveyance direction. As illustrated in FIG. 20C, the binding positions B1 and B2 may be shifted in the main scanning direction and the conveyance direction. However, a positional relationship between the binding positions B1 and B2 is not limited to the example of FIGS. 20A to 20D. The binding positions B1 and B2 may be of parallel binding as illustrated in FIG. 20A, or oblique binding as illustrated in FIGS. 20B to 20D.

The same applies to the binding position B.

A description is given below of an operation and effect according to an embodiment of the present embodiment.

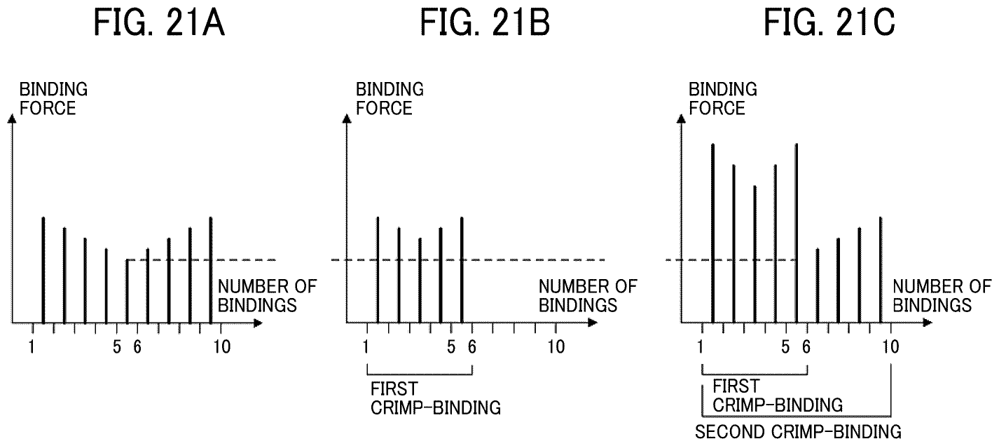

FIG. 21 is a diagram for comparing binding forces of the binding process of FIG. 11 and the binding process of FIG. 15.

As illustrated in the left diagram of FIG. 21, when 10 sheets P are crimped and bound just once, the binding force between the fourth sheet, the fifth sheet, and the sixth sheet is relatively small. On the other hand, as illustrated in the middle diagram of FIG. 21, when the first crimp binding is performed on the first to sixth sheets P, the binding force between the third and fourth sheets is relatively small, but is larger than the minimum binding force in the left diagram of FIG. 21. Furthermore, as illustrated in the right diagram of FIG. 21, when the second crimp binding is performed on the first to tenth sheets P, the binding force between the sixth and seventh sheets is relatively small, but is larger than the minimum binding force in the left diagram of FIG. 21.

As described above, by crimping and binding the sheet bundle Pb constructed of the N sheets P at the time point of the M-th (for example, 6) sheet and the time point of the N-th (for example, 10) sheet, the crimping strength of the sheet P located in a middle part is improved. As a result, it is possible to inhibit separation of the crimped and bound sheet bundle Pb afterwards. In the two times of crimp binding, temporary fixing may be performed with short crimping time (or a weak binding force) in the first crimp binding, and main binding may be performed with longer crimping time (or a stronger binding force) in the second crimp binding.

As illustrated in FIGS. 17A to 17E, a moving distance of the edge binder 25 can be shortened by performing the crimp binding twice at the same binding position B, so that productivity of the post-processing apparatus 3 is improved as compared with the example of FIGS. 19A to 19E. In addition, since there is one binding mark alone, an appearance of the crimped and bound sheet bundle Pb is also improved. On the other hand, as illustrated in FIGS. 19A to 19E, by performing the crimp binding at the different binding positions B1 and B2, the crimping strength can be improved as compared with the example of FIGS. 17A to 17E. However, the binding positions B1 and B2 are desirably as close as possible. Furthermore, the productivity of the post-processing apparatus 3 is further improved by performing the crimp binding just once when the given number N is smaller than the threshold.

Furthermore, according to the above embodiment, by applying the liquid to the binding positions B, B1, and B2, the crimping strength of the sheet P located in a middle part is improved. As a result, it is possible to more effectively inhibit separation of the crimped and bound sheet bundle Pb afterwards. In the examples of FIGS. 16A and 16B and 18A and 18B, one or both of the liquid application to the first to sixth sheets P and the liquid application to the seventh to tenth sheets P may be omitted.

The control method described above may be implemented by, for example, a program. In other words, the control method may be executed by causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

Further, a liquid applier is not limited to the liquid applier described in the above-described embodiments. For example, a liquid applier (liquid application device) and a crimper (crimp binding device) may be separately disposed, and the liquid applier may be disposed in a conveyance passage through which a medium is conveyed to the placing portion, so as to apply liquid to the medium to be placed on the placing portion.

The present disclosure is not limited to specific embodiments described above, and numerous additional modifications and variations are possible in light of the teachings within the technical scope of the appended claims. The above-described embodiments and modifications are some examples, and various modifications and variations can be practiced from such examples by those skilled in the art. Such embodiments and modifications thereof are included in the scope and gist of the embodiments of the present disclosure and are included in the embodiments described in claims and the equivalent scope thereof.

A description is now given below of several aspects of the present disclosure.

### Aspect 1

In Aspect 1, a medium processing apparatus includes a placing portion, a crimp binder, and circuitry. Multiple media including a medium are placed on the placing portion.

The crimp binder performs crimp binding to perform pressure-deforming to bind the multiple media placed on the placing portion. The circuitry is to cause the crimp binder to perform the crimp binding when M (<N) sheets of the media are placed on the placing portion, and cause the crimp binder to perform the crimp binding when N sheets of the media are placed on the placing portion, when binding N sheets of the media.

### Aspect 2

In Aspect 2, in the medium processing apparatus according to Aspect 1, the circuitry is to cause the crimp binder to perform the crimp binding of a first time at a time point when M sheets of the media are placed on the placing portion, M being (N×½−2) or more and less than N, in a case where N is an even number.

### Aspect 3

In Aspect 3, in the medium processing apparatus according to Aspect 1 or Aspect 2, the circuitry is to cause the crimp binder to perform the crimp binding of a first time at a time point when M sheets of the media are placed on the placing portion, M being (N×½−2.5) or more and less than N, in a case where N is an odd number.

### Aspect 4

In Aspect 4, in the medium processing apparatus according to any one of Aspects 1 to 3, the circuitry is to cause the crimp binder to perform the crimp binding at a binding position of M sheets of the media placed on the placing portion, and cause the crimp binder to perform the crimp binding at the binding position of N sheets of the media placed on the placing portion.

### Aspect 5

In Aspect 5, the medium processing apparatus according to Aspect 4 further includes a liquid applier to apply liquid to the medium placed on the placing portion. The circuitry is to cause the liquid applier to apply liquid to the binding position of at least one of first to M-th sheets of the media placed on the placing portion, and cause the liquid applier to apply liquid to the binding position of at least one of (M+1)-th to N-th sheets of the media placed on the placing portion.

### Aspect 6

In Aspect 6, in the medium processing apparatus according to any one of Aspects 1 to 3, the circuitry is to cause the crimp binder to perform the crimp binding at a first binding position of M sheets of the media placed on the placing portion, and cause the crimp binder to perform the crimp binding at a second binding position different from the first binding position of N sheets of the media placed on the placing portion.

### Aspect 7

In Aspect 7, the medium processing apparatus according to Aspect 6 further includes a liquid applier to apply liquid to the medium placed on the placing portion. The circuitry is to cause the liquid applier to apply liquid to the first binding position of at least one of first to M-th sheets of the media placed on the placing portion, and cause the liquid applier to apply liquid to the second binding position of at least one of first to N-th sheets of the media placed on the placing portion.

### Aspect 8

In Aspect 8, in the medium processing apparatus according to any one of Aspects 1 to 7, the circuitry is to cause the crimp binder to perform the crimp binding of a first time when M sheets of the media are placed on the placing portion in a case where N is equal to or larger than a threshold, and to cause the crimp binder to perform the crimp binding of a first time when N sheets of the media are placed on the placing portion in a case where N is smaller than the threshold.

### Aspect 9

In Aspect 9, an image forming system includes an image forming apparatus to form an image on a medium, and the medium processing apparatus according to any one of Aspects 1 to 8.

### Aspect 10

In Aspect 10, a medium processing apparatus includes a placing portion, a crimp binder, and circuitry. Multiple media including a medium are placed on the placing portion. The crimp binder applies pressure and deforms the multiple media to bind the multiple media on the placing portion as a crimp binding process. The circuitry is to, when binding N sheets of the multiple media: cause the crimp binder to perform the crimp binding process when M sheets of the multiple media smaller than the N sheets (M<N) are placed on the placing portion; and cause the crimp binder to perform the crimp binding process again when all the N sheets of the multiple media are placed on the placing portion.

### Aspect 11

In Aspect 11, in the medium processing apparatus according to Aspect 10, the circuitry is further to, when a number of the N sheets is an even number, cause the crimp binder to perform the crimp binding process for a first time when the M sheets of the multiple media are placed on the placing portion, where a number of the M sheets is (N×½−2) or more and less than N.

### Aspect 12

In Aspect 12, in the medium processing apparatus according to Aspect 10 or Aspect 11, wherein the circuitry is further to, when a number of the N sheets is an odd number, cause the crimp binder to perform the crimp binding process for a first time when the M sheets of the multiple media are placed on the placing portion, where a number of the M sheets is (N×½−2.5) or more and less than N.

### Aspect 13

In Aspect 13, in the medium processing apparatus according to any one of Aspects 10 to 12, wherein the circuitry is further configured to cause the crimp binder to perform the crimp binding process, at a predetermined binding position, on the M sheets of the multiple media on the placing portion, and cause the crimp binder to perform the crimp binding process again, at the predetermined binding position, on all the N sheets of the multiple media on the placing portion.

### Aspect 14

In Aspect 14, the medium processing apparatus according to Aspect 13 further includes a liquid applier to apply liquid to the medium to be placed on the placing portion. The circuitry is further to cause the liquid applier to apply the liquid, to at least one of first to M-th sheets of the multiple media on the placing portion, at the binding position, and cause the liquid applier to apply liquid again, to at least one of (M+1)-th to N-th sheets of the multiple media on the placing portion, at the binding position.

### Aspect 15

In Aspect 15, in the medium processing apparatus according to any one of Aspects 10 to 12, the circuitry is further to cause the crimp binder to perform the crimp binding process, at a first binding position, on the M sheets of the multiple media on the placing portion, and cause the crimp binder to perform the crimp binding process again, at a second binding position different from the first binding position, on all the N sheets of the multiple media on the placing portion.

### Aspect 16

In Aspect 16, the medium processing apparatus according to Aspect 15 further includes a liquid applier to apply liquid to the medium to be placed on the placing portion. The circuitry is further to cause the liquid applier to apply liquid, to at least one of first to M-th sheets of the multiple media on the placing portion, at the first binding position, and cause the liquid applier to apply liquid, to at least one of first to N-th sheets of the multiple media on the placing portion, at the second binding position.

### Aspect 17

In Aspect 17, in the medium processing apparatus according to any one of Aspects 10 to 16, the circuitry is further to cause the crimp binder to perform the crimp binding process of a first time when the M sheets of the multiple media are placed on the placing portion, where a number of the N sheets is equal to or larger than a threshold.

### Aspect 18

In Aspect 18, in the medium processing apparatus according to any one of Aspects 10 to 16, the circuitry is further to cause the crimp binder to perform the crimp binding process of a first time when N sheets of the multiple media are placed on the placing portion, where a number of the N sheets is smaller than a threshold.

### Aspect 19

In Aspect 19, an image forming system includes an image forming apparatus to form an image on a medium, and the medium processing apparatus according to any one of Aspects 10 to 18.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a placing portion on which multiple media including a medium are placed;
a crimp binder to apply pressure and deform the multiple media to bind the multiple media on the placing portion as a crimp binding process; and
circuitry configured to, when binding N sheets of the multiple media:
cause the crimp binder to perform the crimp binding process when M sheets of the multiple media smaller than the N sheets (M<N) are placed on the placing portion; and
cause the crimp binder to perform the crimp binding process again when all the N sheets of the multiple media are placed on the placing portion.

2. The medium processing apparatus according to claim 1,
wherein the circuitry is further configured to, when a number of the N sheets is an even number:
cause the crimp binder to perform the crimp binding process for a first time when the M sheets of the multiple media are placed on the placing portion,
where a number of the M sheets is (N×½−2) or more and less than N.

3. The medium processing apparatus according to claim 1,
wherein the circuitry is further configured to, when a number of the N sheets is an odd number:
cause the crimp binder to perform the crimp binding process for a first time when the M sheets of the multiple media are placed on the placing portion,
where a number of the M sheets is (N×½−2.5) or more and less than N.

4. The medium processing apparatus according to claim 1,
wherein the circuitry is further configured to:
cause the crimp binder to perform the crimp binding process, at a predetermined binding position, on the M sheets of the multiple media on the placing portion; and
cause the crimp binder to perform the crimp binding process again, at the predetermined binding position, on all the N sheets of the multiple media on the placing portion.

5. The medium processing apparatus according to claim 4, further comprising a liquid applier to apply liquid to the medium to be placed on the placing portion,
wherein the circuitry is further configured to:
cause the liquid applier to apply the liquid, to at least one of first to M-th sheets of the multiple media on the placing portion, at the binding position; and
cause the liquid applier to apply liquid again, to at least one of (M+1)-th to N-th sheets of the multiple media on the placing portion, at the binding position.

6. The medium processing apparatus according to claim 1,
wherein the circuitry is further configured to:
cause the crimp binder to perform the crimp binding process, at a first binding position, on the M sheets of the multiple media on the placing portion; and
cause the crimp binder to perform the crimp binding process again, at a second binding position different from the first binding position, on all the N sheets of the multiple media on the placing portion.

7. The medium processing apparatus according to claim 6, further comprising a liquid applier to apply liquid to the medium to be placed on the placing portion,
wherein the circuitry is further configured to:
cause the liquid applier to apply liquid, to at least one of first to M-th sheets of the multiple media on the placing portion, at the first binding position; and
cause the liquid applier to apply liquid, to at least one of first to N-th sheets of the multiple media on the placing portion, at the second binding position.

8. The medium processing apparatus according to claim 1,
wherein the circuitry is further configured to cause the crimp binder to perform the crimp binding process of a first time when the M sheets of the multiple media are placed on the placing portion,
where a number of the N sheets is equal to or larger than a threshold.

9. The medium processing apparatus according to claim 1,
wherein the circuitry is further configured to cause the crimp binder to perform the crimp binding process of a first time when N sheets of the multiple media are placed on the placing portion,
where a number of the N sheets is smaller than a threshold.

10. An image forming system comprising:
an image forming apparatus to form an image on a medium; and
the medium processing apparatus according to claim 1.
